(19) United States
(12) Patent Application Publication
(10) Pub. No.: US 2024/0114351 A1
(43) Pub. Date: Apr. 4, 2024

(54) OPTIMIZATION METHOD, COMMUNICATIONS TERMINAL AND AUTOMATON DESIGNED TO OPTIMIZE A COVERAGE OF A LOCAL AREA BY A WIRELESS COMMUNICATIONS NETWORK

(71) Applicant: ORANGE, Issy-les-Moulineaux (FR)

(72) Inventors: Valérie Ledunois, CHATILLON CEDEX (FR); Maxime Jouin, CHATILLON CEDEX (FR); Jeremy Lacoche, CHATILLON CEDEX (FR)

(21) Appl. No.: 18/475,443

(22) Filed: Sep. 27, 2023

(30) Foreign Application Priority Data
Sep. 29, 2022 (FR) 2209928

(51) Int. Cl. H04W 16/18; H04B 7/155; H04B 17/391

(52) U.S. Cl. CPC H04W 16/18; H04B 7/15507; H04B 17/3912; H04W 88/04

(57) ABSTRACT

A method for optimizing coverage by a wireless communications network of a local area, a communications terminal and an automaton designed to optimize a coverage by a wireless communications network of a local area. The method includes provisioning at least one positioning coordinate of at least one repeater within a local area, the at least one positioning coordinate of a repeater being determined as a function at least of a position of at least one socket detected within the local area, the socket being detected using a captured video of the local area. Thus, the coverage of the wireless communications network is optimized as a function of the sockets needed for the installation of repeaters.

### TECHNICAL FIELD

The present disclosure relates to a method for optimizing a coverage by a wireless communications network of a local area, a communications terminal and an automaton designed to optimize a coverage of a local area by a wireless communications network.

### PRIOR ART

Currently, there are many wireless communications networks covering local areas. These notably use communications protocols and/or technologies such as: Wifi™, Bluetooth™, Lifi™, etc.

The drawback of such wireless communications networks is, on the one hand, their reduced range, generally even more so indoors (for example, for Wifi, the range is around 250 m outdoors and 35 m indoors). The range depends in particular on the topology of the premises and on the equipment situated close to a transmitter and/or a receiver, notably to the home router.

One solution is to use a repeater.

In a first alternative, the repeater is a wireless repeater, which is placed in the home router coverage area, for example halfway between the home router and communications equipment placed in a part not covered by the local area. It relays the wireless communications transmissions between the communications equipment present in the parts not covered by the home router of the local area and the home router. In an extended local area, if the communications equipment that the user wishes to connect to the wireless network is very far from the router, the user will need to use several cascaded repeaters which will lead to a higher equipment cost with an increased risk of wireless transmission errors.

In a second alternative, the repeater comprises a wired connection: for example Ethernet™. It may thus be directly placed in the part not covered by the local area where the communications equipment to be connected to the wireless communications network is located if it is equipped with a wired connection socket, since the repeater may then be directly connected to the home router via the wired network of the local area.

Whichever alternative is used, it allows the communications equipment to be connected to the wireless communications network at a given time, but it does not allow it to be ensured that the communications equipment remains connected to the wireless communications network when the latter is moved within the local area since it does not allow it to be ensured that there remains no part not covered by the wireless communications network within the local area.

Currently, new tools are being marketed which are able to map the Wifi coverage of the local area and to estimate the number of access points needed for a continuous and uniform Wifi coverage. The map of the local area is, notably, previously generated by the user by means of simple graphical tools or downloaded as a background image. Then, while the user moves within the local area with a communications terminal connected to the wireless communications network, the tool for mapping the Wifi coverage scans all the Wifi signals that it finds. Then, when the user stops the scan of the local area, the tool for mapping the Wifi coverage draws a thermal map representing the signal-to-noise ratio (SNR), or the signal level, or even the measured noise level, etc. Lastly, it estimates the position of new access points by triangulation of the measurements of signal levels. Such maps lack precision because the thermal map is simply superposed onto a drawing or an image of the map of the local area. Furthermore, the new access points may not necessarily be installed at the estimated positions for various reasons: no electrical socket and/or no Ethernet socket at the estimated position, etc.

### SUMMARY

One subject of the present disclosure is a method for optimizing a coverage by a wireless communications network of a local area comprising a provision of at least one positioning coordinate of at least one repeater within a local area, the at least one positioning coordinate of a repeater being determined as a function at least of a position of at least one socket detected within the local area, the socket being detected using a captured video of the local area.

Thus, the coverage of the wireless communications network is optimized depending on the sockets needed for the installation of repeaters.

Advantageously, the optimization method comprises a detection of the position of sockets detected within the local area, at least one position of at least one socket being detected using a captured video of the local area.

Advantageously, the optimization method comprises a joint capture of a video of the local area and of a position associated with at least one video image of the captured video.

Advantageously, the at least one positioning coordinate of a repeater is furthermore determined as a function of positional data on quality of the wireless communications network.

Advantageously, a positional datum on quality of the wireless communications network is a datum captured within the local area.

Advantageously, the optimization method comprises a capture of the positional data on quality of the wireless communications network.

Advantageously, the optimization method comprises a joint capture of data on quality of the wireless communications network and of a position associated with the quality datum captured.

Advantageously, the optimization method comprises a socket detection using a captured video of the local area.

Advantageously, the optimization method comprises an analysis of the captured video of the local area using which at least one socket is detected within the local area.

Advantageously, the optimization method comprises a determination of the at least one position of at least one socket detected as a function of at least one position associated with at least one video image of the captured video.

Advantageously, the optimization method comprises an insertion into a graphical medium of at least one indicator being a function of at least one repeater positioning coordinate determined within the local area.

Advantageously, the graphical medium is at least one medium from amongst the following:
a map of coverage generated as a function of captured positional data on quality of the wireless communications network;
the captured video of the local area;
an augmented reality medium.

Advantageously, according to one embodiment of the disclosure, the various steps of the method according to the disclosure are implemented by a software application or computer program, this software application comprising software instructions designed to be executed by a data processor of a device, notably a wireless local network coverage optimizer, or of a communications terminal or of an automaton and being designed to control the execution of the various steps of this method.

A subject of the disclosure is therefore also aimed at a program comprising program code instructions for the execution of the steps of the optimization method when said program is executed by a processor.

This program may use any given programming language and may take the form of source code, object code or code intermediate between source code and object code such as in a partially compiled form or in any other desired form.

Another subject of the disclosure is a communications terminal capable of connecting to a wireless communications network comprising a provider of at least one positioning coordinate of at least one repeater within a local area, the at least one positioning coordinate of a repeater being determined as a function at least of a position of at least one socket within the local area, the position of the socket being detected using a captured video of the local area.

Yet another subject of the disclosure is an automaton comprising:
at least one actuator designed to carry out a motor action;
a transmitter/receiver over a wireless communications network;
a provider of at least one positioning coordinate of at least one repeater within a local area to at least one of the actuators, the at least one positioning coordinate of a repeater being determined as a function at least of a position of at least one socket within the local area, the position of the socket being detected using a captured video of the local area.

### BRIEF DESCRIPTION OF THE DRAWINGS

The features and advantages of one or more subjects of the disclosure will become more clearly apparent upon reading the description, presented by way of example, and from the related FIGS. which show:

FIG. 1, a simplified diagram of a method for optimizing coverage of a local area by a wireless communications network according to an exemplary subject of the disclosure,

FIG. 2a, a simplified diagram of a device, notably a communications terminal or an automaton, designed to optimize a coverage of a local area by a wireless communications network according to an exemplary subject of the disclosure,

FIG. 2b, a simplified diagram of one embodiment of the device, notably illustrated in FIG. 2a, in the form of automaton according to an exemplary subject of the disclosure,

FIG. 3a, a simplified diagram illustrating a map of coverage of the wireless communications network into which at least one repeater positioning indicator determined within the local area according to the disclosure is inserted,

FIG. 3b, an image illustrative of an insertion either into a video or in augmented reality mode of a repeater positioning indicator determined within the local area according to an exemplary subject of the disclosure.

### DESCRIPTION OF THE EMBODIMENTS

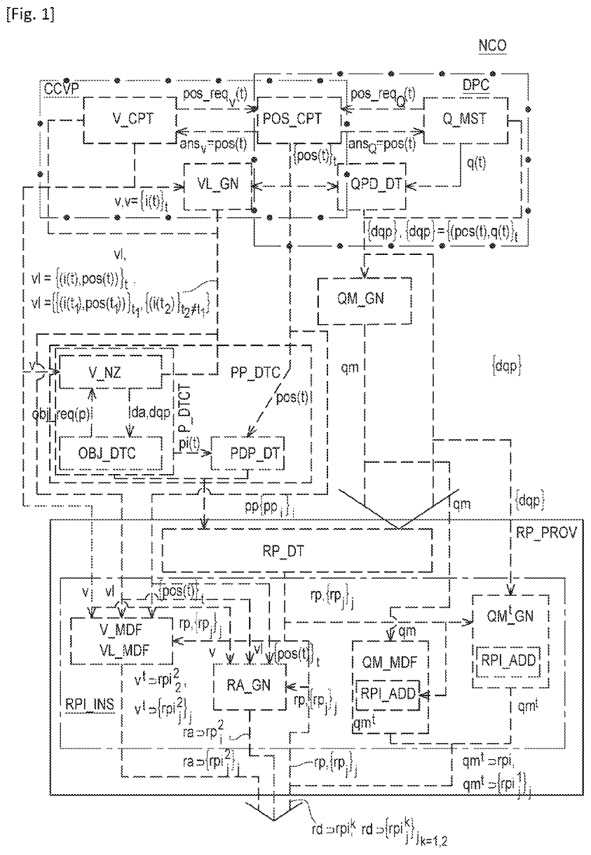

FIG. 1 illustrates a simplified diagram of a method for optimizing coverage of a local area by a wireless communications network according to an exemplary subject of the disclosure.

The method NCO for optimizing a coverage by a wireless communications network of a local area comprises a provision RP_PROV of at least one positioning coordinate of at least one repeater within a local area, the at least one positioning coordinate of a repeater rp, {rpⱼ}ⱼ being determined as a function at least of a position pp, {ppᵢ}ᵢ of at least one socket detected within the local area, the socket being detected using a captured video v, vl of the local area. For example, the provision RP_PROV of at least one positioning coordinate of at least one repeater supplies at least one datum relating to at least one repeater rd comprising at least one positioning coordinate of a repeater rp, {rpⱼ}ⱼ: rd⊃rpi^{k},rd⊃{rpiⱼ^{k}}_{j′}_{^{k=1,2}}.

In particular, the optimization method NCO comprises a detection PP_DTC of a position pp, {ppᵢ}ᵢ of sockets detected within the local area, at least one position pp, {ppᵢ}ᵢ of at least one socket being detected using a captured video v, vl of the local area.

In particular, the optimization method NCO comprises a joint capture CCVP of a video v={i(t)} of the local area and of a position pos(t) associated with at least one video image i(t) of the captured video, such as a captured image and/or a frame of the captured video.

In particular, the at least one positioning coordinate of a repeater rp, {rpⱼ}ⱼ is furthermore determined as a function of positional data on quality dqp(t) of the wireless communications network, dqp(t)=(pos(t),q(t)).

In particular, a positional datum on quality dqp(t) of the wireless communications network is a datum captured within the local area.

In particular, the optimization method NCO comprises a capture DPC of the positional data on quality of the wireless communications network.

In particular, the optimization method comprises a joint capture DPC of data on quality of the wireless communications network q(t) and of a position pos(t) associated with the quality datum captured.

In particular, the optimization method NCO comprises a socket detection OBJ_DTC using a captured video v, vl of the local area.

In particular, the optimization method NCO comprises an analysis V_NZ of the captured video v, vl of the local area based on which at least one socket is detected OBJ_DTC within the local area.

In particular, the optimization method NCO comprises a determination PDP_DT of the at least one position pp, {ppᵢ}ᵢ of at least one socket detected as a function of at least one position pos(t), pos(t₁} associated with at least one video image, such as an image and/or a frame i(t), i(t₁) of the captured video v, vl.

In particular, the optimization method NCO comprises an insertion RPI_INS into a graphical medium v, vl, ra, qm of at least one indicator rpi, {rpiⱼ}ⱼ being a function of at least one repeater positioning coordinate rp, {rpⱼ}ⱼ determined within the local area.

In particular, the graphical medium is at least one medium from amongst the following:
a map of coverage qm generated as a function of captured positional data dqp(t) on quality of the wireless communications network;
the captured video v, vl of the local area;
an augmented reality medium ra.

The map qm of coverage is notably a two-dimensional, three-dimensional map and/or a thermal map, etc.

In particular, the optimization method NCO comprises a capture of a video V_CPT in which at least one socket is detected allowing the optimization method NCO to provide a positioning coordinate of a repeater. The captured video v, vl is notably composed of a series of video images v={i(t)}ₜ, notably of images and/or of frames, potentially coupled to a position of the video image within the local area vl={i(t), pos(t)}ₜ, vl={{i(t₁),pos(t₁)}_{t1≠t2},{i(t₂)ₜ₂}.

In a first alternative, the video capture V_CPT comprises a position capture (not illustrated); thus, the video capture V_CPT provides a localized video vl.

In a second alternative, the video capture V_CPT receives, for example following a position request pos_req_{V}(t), from a position capture POS_CPT, notably carried out by the optimization method NCO, a current position pos(t), respectively in a response ans_{V}=pos(t) to the position request, that the video capture associates with the current video image captured i(t): vl={(i(t),pos(t)}ₜ, such as the current image, and/or with the current frame, notably in the form of metadata.

In a third alternative, the optimization method NCO comprises a generation of localized video VL_GN generating from the video v captured by the video capture V_CPT and from at least one position pos(t), pos(t1) of the video sensor implementing the video capture V_CPT a localized video vl={{i(t₁),pos(t₁)}_{t1≠t2},{i(t₂)ₜ₂}. The position of the video sensor is provided by a position capture POS_CPT, notably carried out by the optimization method NCO.

In particular, the optimization method NCO comprises a joint video/position capture CCVP comprising the video capture V_CPT, potentially the position capture POS_CPT, and notably the generation of localized video VL_GN. The joint video/position capture CCVP thus provides a localized video vl of the local area.

In particular, the optimization method NCO comprises a capture Q_MST of datum on quality q(t) of the wireless communications network, also called measurement of quality of the wireless communications network.

In a first alternative, the quality capture Q_MST comprises a position capture (not illustrated), thus the quality capture Q_MST provides a positional quality datum dqp(t).

In a second alternative, the quality capture Q_MST receives, for example following a position request pos_req_{Q}(t), from a position capture POS_CPT, notably carried out by the optimization method NCO, a current position pos(t), respectively in a response ans_{Q}=pos(t) to the position request, that the quality capture Q_MST associates with the current captured quality datum q(t): dqp(t)=(q(t),pos(t)).

In a third alternative, the optimization method NCO comprises a determination of positional quality data DQP_DT generating, based on the quality datum captured q(t) by the quality capture Q_MST and on at least one position pos(t) of the quality sensor implementing the quality capture Q_MST, a positional quality datum dqp(t)=(q(t),pos(t)). The position of the quality sensor is provided by a position capture POS_CPT, notably carried out by the optimization method NCO.

In particular, the optimization method NCO comprises a joint quality/position capture DPC comprising the quality capture Q_MST, potentially the position capture POS_CPT, and notably the determination of a positional quality datum QPD_DT. The joint quality/position capture DPC thus provides a positional quality datum dqp(t) of the local area.

In particular, the optimization method NCO comprises a generation QM_GN of a map qm of coverage as a function of the positional data {dqp} captured on quality of the wireless communications network.

In particular, the optimization method NCO comprises a position capture POS_CPT providing a position pos(t) of the device, notably of a communications terminal or of an automaton, implementing the optimization method at a time t.

In particular, as FIG. 1 illustrates, the optimization method NCO comprises, in particular, a single position capture POS_CPT which then provides a position pos(t) which is both the position of the video sensor at the time t of capture of the image and/or of the frame i(t) of the captured video and the position of the quality sensor at the time t of capture of the quality datum q(t) at the position pos(t).

Notably, when the device comprises a video sensor, the position capture POS_CPT provides the position of the video sensor at the time t of capture of the image and/or of the frame i(t) of the captured video v, vl; and/or, when the device comprises a quality sensor, the position capture POS_CPT provides the position of the quality sensor at a time t of capture of the quality q(t).

In particular, the optimization method NCO comprises a detection of objects OBJ_DTC in a video OBJ_DTC detecting at least one socket pi in a captured video v, vl.

In particular, the optimization method NCO comprises a video analysis V_NZ processing the captured video v, respectively the localized video vl, providing analysis data da, respectively positional analysis data dap.

The detection of objects OBJ_DTC detects at least one socket pi, or a position of at least one socket pp, {ppᵢ}ᵢ, by video analysis V_NZ. For example, the detection of objects OBJ_DTC detects the at least one socket pi, or the position of at least one socket pp, {ppᵢ}ᵢ as a function of analysis data da, respectively of positional analysis data dap provided by the video analysis, for example subsequent to a request for an object of the socket type obj_req(p) from the detection of objects OBJ_DTC at the video analysis V_NZ.

In particular, the optimization method NCO comprises a determination of the position of detected sockets PDP_DT depending on the socket detected pi(t), for example at a time t of the captured video v, and on the captured position pos(t) at the same time t. Notably, the determination of the position of detected sockets PDP_DT receives data relating to the sockets pi(t) detected by the detection of objects OBJ_DTC and positions pos(t) captured by a position capture of the video sensor, potentially the position capture POS_CPT illustrated in FIG. 1.

In a first alternative, the detection PP_DTC of the at least one position pp, {ppᵢ}ᵢ of at least one socket detected within the local area comprises the detection of objects OBJ_DTC in the captured localized video vl.

In a second alternative, the detection PP_DTC of the at least one position pp, {ppᵢ}ᵢ of at least one socket detected within the local area comprises the detection of objects OBJ_DTC in the captured video vl and the determination of the position PDP_DT of the at least one socket pi detected by the detection of objects OBJ_DTC in a video v as a function of the captured positions pos(t). Notably, a position determined of a detected socket pp, {ppᵢ}ᵢ is the position captured at a time t corresponding to the time t of capture of a video image i(t) of the captured video v, a video image i(t) in which a socket pi(t) is detected.

In particular, the optimization method NCO comprises a determination of repeater positioning coordinates RP_DT as a function of at least one position pp, {ppᵢ}ᵢ of at least one socket pi(t) detected within the local area using a captured video v, vl of the local area. Notably, the determination of repeater positioning coordinates RP_DT receives the at least one position of at least one detected socket pp, {ppᵢ}ᵢ coming from the socket position detection PP_DTC from a captured video v, vl of the local area and/or from a determination of positions PDP_DT of detected sockets pi(t) and/or from a detection of objects OBJ_DTC using a captured localized video vl. Notably, the determination of repeater positioning coordinates RP_DT calculates one or more of the following elements:
a communications network coverage using a repeater connected to at least one detected socket;
an optimum position of a repeater as a function of the coverage of the wireless communications network measured by the captured positional quality data dqp(t) and depending on the type of repeater. For example, the determination of repeater positioning coordinates RP_DT calculates the positioning coordinates of a repeater by triangulation.

The provision of repeater positioning coordinates RP_PROV notably comprises the determination of repeater positioning coordinates RP_DT.

In particular, the optimization method NCO comprises an insertion RPI_INS into a graphical medium v, vl, ra, qm, qm+ of a repeater indicator rpi, rpi¹, rpi², rpi^{k}, the insertion being a function of at least one repeater positioning pr, {rpⱼ}ⱼ determined within the local area.

The provision of repeater positioning coordinates RP_PROV notably comprises the insertion RPI_INS into a graphical medium v, vl, ra, qm, qm+ of a repeater indicator rpi, rpi¹ rpi², rpi^{k}.

In particular, the optimization method NCO comprises a modification V_MDF, VL_MDF of the captured video v, or even of the captured localized video vl by means of at least one repeater indicator rpi², rpi²ⱼ. The modification of the video V_MDF, VL_MDF is a function of at least one repeater positioning coordinate pr, {rpⱼ}ⱼ determined within the local area. Notably, the repeater indicator rpi², rpi²ⱼ is added to the video image i(t) of the video v, vl corresponding to the coordinate determined for positioning of the repeater pp, ppi, notably directly into the video image, by chroma keying into the video image or by being superimposed onto the video image, etc. The insertion RPI_INS notably comprises the video modification V_MDF, VL_MDF. Thus, a datum provided relating to the repeater rd notably comprises a modified video v+, vl+ comprising at least one repeater indicator rpi², rpi²ⱼ: v⁺⊃rpi²,vl⁺⊃{rpiⱼ²}ⱼ.

In particular, the optimization method NCO comprises a generation of augmented reality data RA_GN comprising at least one repeater indicator rpi², rpi²ⱼ: ra⊃rpi²,ra⊃{rpiⱼ²}ⱼ. The insertion RPI_INS notably comprises the generation of augmented reality data RA_GN. Thus, a datum provided relating to the repeater rd notably comprises augmented reality data ra.

In particular, the optimization method NCO comprises an update QM_MDF of a map of coverage qm generated as a function of captured positional data dqp(t) on quality of the wireless communications network, the update QM_MDF being a function of at least one positioning coordinate rp, {rpⱼ}ⱼ determined for at least one repeater. For example, the update of maps of coverage QM_MDF comprises an addition RPI_ADD of a repeater indicator rpi¹, rpi¹ⱼ to the map of coverage qm previously generated QM_GN notably by the optimization method NCO. The updated map qm+ thus comprises at least one repeater indicator rpi1, rpi1j positioned on the map as a function of the at least one positioning coordinate of the repeater rp, rpⱼ thus indicated. The insertion RPI_INS notably comprises the update QM_MDF of a map of coverage qm previously generated.

In particular, the optimization method NCO comprises a generation QM+_GN of a repeater positioning map qm+ not only as a function of captured positional data dqp(t) on quality of the wireless communications network but also of at least one positioning coordinate rp, {rpⱼ}ⱼ determined for at least one repeater. For example, the generation of positioning maps of repeaters QM+_GN comprises an addition RPI_ADD of a repeater indicator rpi¹, rpi¹ⱼ to a map generated by the repeater positioning map generation QM+_GN. For example, the generation of repeater positioning maps QM+_GN comprises a generation (not illustrated) of a map of coverage qm as a function of captured positional data dqp(t) on quality of the wireless communications network prior to the repeater indicator addition RPI_ADD. The repeater positioning map qm+ thus comprises at least one repeater indicator rpi1, rpi1j positioned on the map as a function of the at least one positioning coordinate of the repeater rp, rp j thus indicated. The insertion RPI_INS notably comprises the generation QM+_GN of a repeater positioning map qm+.

The map qm+, a modified map of coverage or a repeater positioning map, is obtained:
either by integration of the at least one repeater indicator rpi1, rpi1j into the map previously generated qm,
or by superimposing the at least one repeater indicator rpi1, rpi1j onto the map previously generated qm, etc.

The map qm+, a modified map of coverage or a repeater positioning map, is notably a two-dimensional, three-dimensional, etc. map, and/or a thermal map, etc.

For example, the indicator rpi¹, rpi¹ⱼ, rpi², rpi²ⱼ comprises a frame piⱼ framing at least one detected socket at a positioning coordinate determined for a repeater and, potentially, a repeater symbol rs, rsⱼ notably allowing the type of repeater (wireless, wired, etc.) to be indicated. The repeater symbol rs, rsⱼ is notably an alphanumeric symbol, such as a name, an acronym, etc., and/or a graphical symbol. In the case of a wireless repeater, the frame piⱼ frames an electrical socket and a wired communications socket, for example Ethernet.

Thus, a datum provided relating to the repeater rd notably comprises a map qm+, either a modified map of coverage or a repeater positioning map.

In particular, the optimization method NCO comprises a command generation for an automaton CMD_GN (not illustrated). The command cmd(rp), {cmdⱼ(rpⱼ)}ⱼ, cmd({rpⱼ}ⱼ) thus generated allows the automaton to be moved to a positioning coordinate determined for a repeater. When several repeaters are determined, the command generation CMD_GN generates either a command cmd allowing the automaton to be moved successively to each of the positioning coordinates determined for the repeaters or a series of commands {cmdⱼ(rpⱼ)}ⱼ, each separate command cmdⱼ allowing the automaton to be moved to a distinct positioning coordinate determined for one of the repeaters.

In a first alternative, the command generated allows the automaton to be commanded to indicate the positioning of the repeater, for example by means of a light beam directed toward the connection socket or sockets of the repeater, electronic socket and/or wired communications socket, or by means of an automated arm.

In a second alternative, the command generated allows the automaton to be commanded to connect a repeater to the socket, or else to the sockets depending on the type of repeater, located at the positioning coordinate determined for the repeater, notably by controlling a robotic arm of the automaton.

The provision of repeater positioning coordinates RP_PROV notably comprises the command generation CMD_GN. The datum relating to the repeater rd then comprises the automaton command thus generated cmd.

One particular embodiment of the optimization method is a program comprising program code instructions for the execution of the steps of the optimization method when said program is executed by a processor.

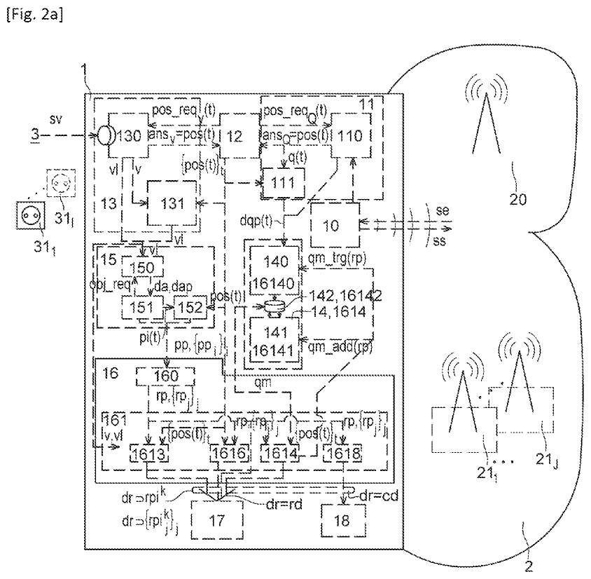

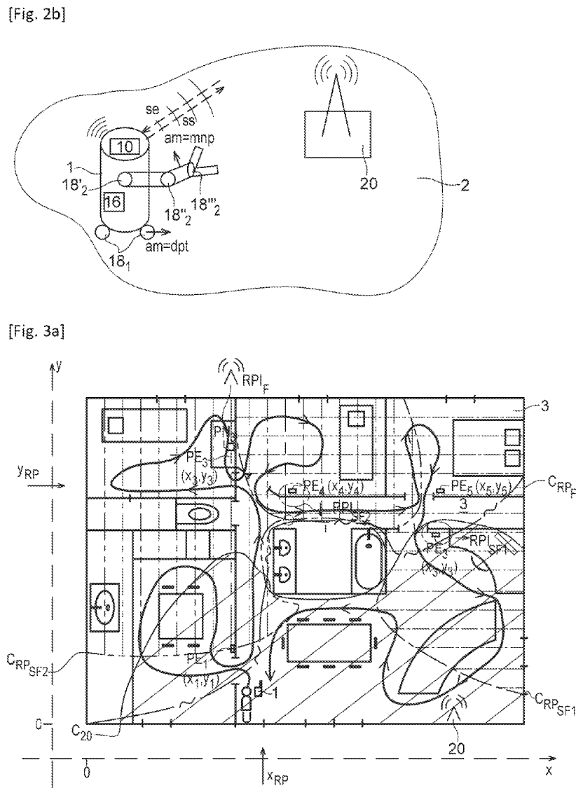

FIG. 2a illustrates a simplified diagram of a device, notably a communications terminal or an automaton, capable of optimizing a coverage of a local area by a wireless communications network according to an exemplary subject of the disclosure.

The device 1 is notably a device from amongst the following:
a communications terminal able to connect to a wireless communications network;
an automaton comprising:
   at least one actuator 18, 181, 182′, 182″, 182′″ designed to perform a motor action am;
   a transmitter/receiver 10 over a wireless communications network 2.

FIG. 2a shows a wireless communications network 2 notably generated by at least one communications device 20, such as a home router or a home system gateway able to exchange signals via this wireless communications network with at least one unit of communications equipment present in the coverage area of the wireless communications network.

The local area 3 that the user wishes to cover with the wireless communications network 2 comprises one or more sockets 31₁ . . . 31_{I} to which at least one repeater 21₁ . . . 21_{J} may be connected either as a power supply (electrical socket) or for communicating (wired communications socket, such as Ethernet).

In particular, a device 1 or at least one peripheral (not illustrated) of the device 1 comprises:
at least one video sensor 13, 130; and
potentially, a position sensor 12.

In particular, the video sensor 13, 130 and, potentially, the position sensor 12 are connected to a detector relating to the sockets 151, 15. Notably, when the detector is a socket detector 151, the video sensor 13, 130 and, potentially, the position sensor 12 are connected to a video analyzer 150 connected to the socket detector 151. In particular, the device 1 comprises the detector relating to the sockets 151, 15.

In particular, a device 1 or at least one peripheral (not illustrated) of the device 1 comprises:
a communications module 10 able to exchange via the wireless communications network 2, notably a transmitter/receiver designed to transmit an outgoing signal ss and/or to receive an incoming signal se via the wireless communications network 2,
at least one quality sensor 11, 110; and
potentially, a position sensor 12.

For example, the peripheral of the device 1 is a nomad device connected to the device 1, for example via a local network potentially distinct from the wireless communications network 2 (in particular when the device 1 comprises the video sensor 13, 130). Thus, when the device 1 is not a nomad device, the use of the peripheral facilitates the video and/or quality captures within the local area.

In particular, the quality sensor 11, 110 and, potentially, the position sensor 12 are connected to a map generator 14, 140 relating to the wireless communications network 2. In particular, the device 1 comprises the map generator 14, 140.

The device 1 comprises a provider 16 of at least one positioning coordinate of at least one repeater 21₁ . . . 21_{N} within a local area 3. The provider 16 is connected to the detector relating to the sockets 15, 150 and, either to the quality sensor 11, 110 or to the map generator 14, 140.

In particular, the provider of repeater positioning coordinates 16 is connected to a reproduction module or system 17, such as a display (2D, 3D, etc.), notably a screen, a holograph, and/or a loud speaker, a 3D audio production system, etc. Thus, the indicators of repeaters are reproduced visually and/or in an audio manner. For example, an audio repeater indicator may be a sound whose volume increases when the user gets closer to the at least one positioning coordinate of the repeater, and/or a 3D sound reproduced in such a manner that the user perceives it as coming from the at least one positioning coordinate of the repeater of the local area. Notably, the device 1 comprises the reproduction module/system 17.

In particular, the provider of repeater positioning coordinates 16 is connected to at least one actuator 18, such as a moving device, a robot arm, etc. Notably, the actuator 18 is an actuator of an automaton connected to the device 1 or of the device 1 constituting an automaton.

In particular, the device 1 comprises an optimizer 19 of coverage of a local area by the wireless communications network. The optimizer 19 comprises the provider 16 of repeater positioning coordinates within the local area 3, and potentially at least one of the following devices:
at least one video sensor 13, 130;
a position sensor 12.
at least one quality sensor 11, 110;
a map generator 14, 140 relating to the wireless communications network 2;
a detector relating to the sockets 151, 15.

The device 1 comprises a provider 16 of at least one positioning coordinate of at least one repeater 21₁ . . . 21_{N} within a local area 3. The at least one positioning coordinate of a repeater rp, {rpⱼ}ⱼ is determined as a function at least of a position pp, {ppᵢ}ᵢ of at least one socket detected within the local area. The socket is detected using a captured video v, vl of the local area 3. For example, the provider 16 of at least one positioning coordinate of at least one repeater supplies at least one datum rd relating to at least one repeater comprising at least one positioning coordinate of a repeater rp, {rpⱼ}ⱼ: rd⊃rpi^{k},rd∈{rpiⱼ^{k}}_{j′}_{^{k=1,2}}.

The device 1 notably comprises a communications module 10, also called transmitter and/or receiver, over a wireless communications network 2.

In particular, a video sensor 130 captures a video v, vl in which at least one socket 31₁ . . . 31_{I} is detected allowing the provider 16 to provide a positioning coordinate of a repeater. The captured video v, vl is notably composed of a series of video images v={i(t)}ₜ, potentially coupled to a position of the video image within the local area vl={i(t), pos(t)}ₜ, vl={{i(t₁),pos(t₁)}_{t1≠t2},{i(t₂)ₜ₂}. Notably, the device 1 comprises the video sensor 130.

In particular, a localized video sensor 13 providing a captured localized video vl, notably the captured video comprises, in the metadata of at least one video image i(t) of the video vl⊃{i(t)}ₜ, the position of capture of the video image pos(t): vl⊃i(t)↔pos(t). The localized video sensor 13 comprises potentially the video sensor 130. Notably, the device 1 comprises the localized video sensor 13.

In a first alternative, the video sensor 130 comprises a position sensor (not illustrated), thus the video sensor 130 provides a localized video vl. In particular, the localized video sensor 13 is then constituted by the video sensor 130.

In a second alternative, the video sensor 130 receives, for example following a position request pos_req_{V}(t), from a position sensor 12, notably implemented in the device 1, a current position pos(t), respectively in a response ans_{V}=pos(t) to the position request, that the video sensor 130 associates with the current captured video image i(t): vl={(i(t),pos(t)}, notably in the form of metadata. In particular, either the localized video sensor 13 then consists of the video sensor 130 or the localized video sensor 13 comprises the video sensor 130 and the position sensor 12.

In a third alternative, a generator of localized video 131 is designed to generate, starting from the video v captured by the video sensor 130 and from at least one position pos(t), pos(t1) of the video sensor 130, a localized video vl={{i(t₁),pos(t₁)}_{t1≠t2},{i(t₂)ₜ₂}. The position of the video sensor 130 is provided by a position sensor 12, implemented in the device 1 (when the device 1 comprises the video sensor 130) or in a video peripheral (not illustrated) of the device 1 (when the video peripheral comprises the video sensor 130). A peripheral of the device 1 is an electronic interface connected to the device 1 designed to provide the device 1 with a signal which is a function of a sensed or input signal. In particular, the localized video sensor 13 comprises the video sensor 130, the generator of localized video 131, and potentially the position sensor 12.

In particular, the sensor of localized video 13 is a joint video/position sensor comprising the video sensor 130, potentially the position sensor 12, and notably the generator of localized video 131. The joint video/position sensor 13 thus provides a localized video vl of the local area.

In particular, a quality sensor 110 captures data q(t) on quality of the wireless communications network, also called measurement of quality of the wireless communications network. Notably, the device 1 comprises the quality sensor 110.

In particular, a positional quality sensor 11 provides positional data dqp(t) on quality of the wireless communications network. The positional quality sensor 11 potentially comprises the quality sensor 110. Notably, the device 1 comprises the positional quality sensor 11.

In a first alternative, the quality sensor 110 comprises a position sensor (not illustrated), thus the quality sensor 110 provides a positional quality datum dqp(t). In particular, the positional quality sensor 11 then consists of the quality sensor 110.

In a second alternative, the quality sensor 110 receives, for example following a position request pos_req_{Q}(t), from a position sensor 12, notably implemented in the device 1, a current position pos(t), respectively in a response ans_{Q}=pos(t) to the position request, that the quality sensor 110 associates with the current captured quality datum q(t): dqp(t)=(q(t),pos(t)). In particular, either the positional quality sensor 11 then consists of the quality sensor 110 or the positional quality sensor 11 comprises the quality sensor 110 and the position sensor 12.

In a third alternative, a positional quality processor 111 is able to determine, starting from the quality datum captured q(t) by the quality sensor 110 and from at least one position pos(t) of the quality sensor 110, a positional quality datum dqp(t)=(q(t),pos(t)). The position of the quality sensor 110 is provided by a position sensor 12, notably implemented by the device 1 (when the latter comprises the quality sensor 110) or in a peripheral (not illustrated) of the device 1 (when the peripheral comprises the quality sensor 110). In particular, the positional quality sensor 11 comprises the quality sensor 110, the positional quality processor 111, and potentially the position sensor 12.

In particular, the positional quality sensor 13 is a joint quality/position sensor comprising the quality sensor 110, potentially the position sensor 12, and notably the positional quality datum processor 111. The joint quality/position sensor 13 thus provides a positional quality datum dqp(t) of the local area 3.

In particular, a generator 140, 16140 of coverage maps is designed to generate a map qm of coverage of a wireless communications network as a function of captured positional data {dqp} on quality of the wireless communications network, for example received from a quality sensor 110 or from a positional quality sensor 11. Notably, the device 1 comprises the coverage map generator 140, 16140.

In particular, a position sensor 12 is designed to provide a position pos(t). The position pos(t) provided by the position sensor 12 is a position captured by the position sensor 12 at the time t. Thus, when the position sensor 12 is implemented in or co-localized with a video sensor 130, a localized video sensor 13, a quality sensor 110, a positional quality sensor 11, and/or the device 1, the captured position provided by the position sensor at the time t: pos(t) is the position respectively of the video sensor 130, of the localized video sensor 13, of the quality sensor 110, of the positional quality sensor 11, and/or of the device 1. Notably, the device 1 comprises the position sensor 12.

In particular, as illustrated in FIG. 2a, the device 1 notably comprises a single position sensor 12 which then provides a position pos(t) which is both the position of the video sensor 13, 130 at the time t of capture of the video image i(t), such as the image and/or the frame, of the captured video and the position of the quality sensor 11, 110 at the time t of capture of the quality datum q(t) at the position pos(t).

Notably, when the device 1 comprises a video sensor 13, 130, the position sensor 12 provides the position of the video sensor at the time t of capture of the video image i(t), such as the image and/or the frame, of the captured video v, vl; and/or when the device 1 comprises a quality sensor, the position sensor 12 provides the position of the quality sensor at a time t of capture of the quality q(t).

In particular, a detector of objects 151 in a video is able to detect at least one socket pi in a captured video v, vl, notably provided by the video sensor 130 or the localized video sensor 13. Notably, the device 1 comprises the detector of objects 151.

In particular, a video analyzer 150 is designed to process the captured video v, respectively the localized video vl, and to provide analysis data da, respectively positional analysis data dap. Notably, the device 1 comprises the video analyzer 150.

Notably, the detector of objects 151 is able to detect at least one socket pi, or even a position of at least one socket pp, by video analysis notably by means of the video analyzer 150. For example, the detector of objects 151 is able to detect the at least one socket pi, or even the position of at least one socket pp, {ppᵢ}ᵢ as a function of analysis data da, respectively of positional analysis data dap, provided by the video analyzer 150, for example subsequent to a request for an object of the socket type obj_req(p) from the detector of objects 151 to the video analyzer 150.

In particular, a detected socket position processor 152 is able to determine a position of at least one detected socket as a function of the socket detected pi(t), for example at a time t of the captured video v, and of the position pos(t) captured at the same time t. Notably the detected socket position processor 152 is able to receive data relating to the sockets pi(t) detected by the detector of objects 151 and positions pos(t) captured by a position sensor 12 of the video sensor, potentially the position sensor 12 illustrated in FIG. 2a. Notably, the device 1 comprises the detected sockets position processor 152.

In particular, a detected socket position detector 15 is designed to detect at least one position of at least one socket detected in a captured video. Notably, the device 1 comprises the detected socket position detector 15.

In a first alternative, the detector 15 of the at least one position pp, {ppᵢ}ᵢ of at least one socket detected within the local area comprises the detector of objects 151 in the captured localized video vl.

In a second alternative, the detector 15 of the at least one position pp, {ppᵢ}ᵢ of at least one socket detected within the local area comprises the detector of objects 151 in the captured video vl and the processor for the position 152 of sockets pi detected by the detector of objects 151 in a video v as a function of the captured positions pos(t). Notably, a position determined of a detected socket pp, {ppᵢ}ᵢ is the position captured at a time t corresponding to the time t of capture of a video image i(t) of the captured video v, a video image i(t) in which a socket pi(t) is detected.

In particular, an analyzer of coverage of a wireless communications network 160, also called wireless network coverage analyzer, is designed to determine at least one positioning coordinate of at least one repeater as a function of at least one position pp, {ppᵢ}ᵢ of at least one socket pi(t) detected within the local area 3 using a captured video v, vl of the local area. Notably, the wireless network coverage analyzer 160 receives the at least one position of at least one detected socket pp, {ppᵢ}ᵢ coming from the socket position detector 15 using a captured video v, vl of the local area and/or a processor for positions 152 of detected sockets pi(t) and/or a detector of objects 151 using a captured localized video vl. Notably, the wireless network coverage analyzer 160 calculates one or more of the following elements:
a communications network coverage from a repeater connected to at least one detected socket;
an optimum position of a repeater as a function of the coverage of the wireless communications network measured by the captured positional quality data dqp(t) and depending on the type of repeater. For example, the wireless network coverage analyzer 160 calculates the positioning coordinates of a repeater by triangulation. The device 1 comprises, for example, the wireless network coverage analyzer 160.

The provider of repeater positioning coordinates 16 notably comprises the wireless network coverage analyzer 160.

In particular, a repeater indicator integrator 161 is designed to insert a repeater indicator rpi, rpi¹, rpi², rpi^{k} into a graphical medium v, vl, ra, qm, qm+ as a function of at least one repeater positioning pr, {rpⱼ}ⱼ determined within the local area 3. The device 1 comprises, for example, the repeater indicator integrator 161.

The provider of repeater positioning coordinates 16 notably comprises the repeater indicator integrator 161.

In particular, a video modifier 1613 is designed to modify the captured video v, or else the captured localized video vl, by means of at least one repeater indicator rpi², rpi²ⱼ. The video modifier 1613 carries out the modification as a function of at least one repeater positioning coordinate pr, {rpⱼ}ⱼ determined within the local area. Notably, the video modifier 1613 adds the repeater indicator rpi², rpi²ⱼ to the video image i(t) of the video v, vl corresponding to the repeater positioning coordinate determined pp, ppi, notably directly in the video image, by chroma keying into the video image or by superimposing onto the video image, etc. The device 1 comprises, for example, the video modifier 1613.

The repeater indicator integrator 161 notably comprises the video modifier 1613. Thus, a datum provided relating to the repeater rd notably comprises a modified video v+, vl+ comprising at least one repeater indicator rpi², rpi²ⱼ: v⁺⊃rpi², vl⁺⊃{rpiⱼ²}ⱼ.

In particular, an augmented reality data generator 1616 is designed to create an augmented reality by means of reproducible augmented reality data, the augmented reality data thus generated comprising at least one repeater indicator rpi², rpi²ⱼ: ra⊃rpi²,ra⊃{rpiⱼ²}ⱼ. The device 1 comprises, for example, the augmented reality data generator 1616.

The repeater indicator integrator 161 notably comprises the augmented reality data generator 1616. Thus, a datum provided relating to the repeater rd notably comprises augmented reality data ra.

In particular, a coverage map adapter 141, 16141 is designed to update a map of coverage qm generated as a function of captured positional data dqp(t) on quality of the wireless communications network as a function of at least one positioning coordinate rp, {rpⱼ}ⱼ determined for at least one repeater. For example, the coverage map adapter 141, 16141 comprises an incorporator (not illustrated) designed to insert a repeater indicator rpi¹, rpi¹ⱼ into the map of coverage qm previously generated notably by the map generator 140, 1640. The updated map qm+ thus comprises at least one repeater indicator rpi1, rpi1j positioned onto the map as a function of the at least one positioning coordinate of the repeater rp, rp j thus indicated. The device 1 comprises, for example, the coverage map adapter 141, 16141.

The repeater indicator integrator 161 notably comprises the coverage map adapter 16141 previously generated.

In particular, a generator 1614 generates a map of repeater positioning qm+ not only as a function of captured positional data dqp(t) on quality of the wireless communications network but also of at least one positioning coordinate rp, {rpⱼ}ⱼ determined for at least one repeater. For example, the repeater positioning map qm+ generator 1614 comprises an incorporator (not illustrated) designed to insert a repeater indicator rpi¹, rpi¹ⱼ into a map generated by the repeater positioning map generator 1614. For example, the repeater positioning map generator 1614 comprises a coverage map qm generator 16140 as a function of captured positional dqp(t) on quality of the wireless communications network and a repeater indicator integrator 16141, the integrator 16141 being designed to insert at least one repeater indicator into the generated map provided by the coverage map generator 16140. The repeater positioning map qm+ thus comprises at least one repeater indicator rpi1, rpi1j positioned on the map as a function of the at least one positioning coordinate of the repeater rp, rpⱼ thus indicated. The device 1 comprises, for example, the coverage map adapter 141, 16141.

The repeater indicator integrator 161 notably comprises the repeater positioning map qm+ generator 1614.

The map qm+, modified map of coverage or repeater positioning map, is obtained:
either by integration of the at least one repeater indicator rpi1, rpi1j into the map previously generated qm,
or by chroma keying of the at least one repeater indicator rpi1, rpi1j into the map previously generated qm,
or by superimposing the at least one repeater indicator rpi1, rpi1j onto the map previously generated qm, etc.

For example, the indicator rpi¹, rpi¹ⱼ, rpi², rpi²ⱼ comprises a frame piⱼ framing at least one socket detected at a positioning coordinate determined for a repeater and, potentially, a repeater symbol rs, rsⱼ notably allowing the type of repeater (wireless, wired, etc.) to be indicated. The repeater symbol rs, rsⱼ is notably an alphanumeric symbol, such as a name, an acronym, etc., and/or a graphical symbol. In the case of a wireless repeater, the frame pi, frames an electrical socket and a wired communications socket, for example Ethernet. Potentially, the indicator rpi¹, rpi¹ⱼ, rpi², rpi²ⱼ furthermore comprises a 3D position symbol ip, ipⱼ, the 3D position symbol notably indicating the height of the socket at the positioning coordinate of the socket on a two-dimensional map qm+. Thus, a datum provided relating to the repeater rd notably comprises a map qm+, being either a modified coverage map or a repeater positioning map.

In particular, a command generator 1618 is designed to generate at least one command cmd(rp), {cmdⱼ(rpⱼ)}ⱼ, cmd({rpⱼ}ⱼ) for moving at least one automaton to a positioning coordinate determined for a repeater. When several repeaters are determined, the automaton command generator 1618 is able to generate either a command cmd designed to move the automaton successively to each of the positioning coordinates determined for the repeaters or a series of commands {cmdⱼ(rpⱼ)}ⱼ, each separate command cmdⱼ being able to move the automaton to a distinct positioning coordinate determined for one of the repeaters.

In a first alternative, the command generated is able to command the automaton to indicate the positioning of the repeater, for example by means of a light beam directed toward the connection socket or sockets of the repeater, electronic socket and/or wired communications socket, or by means of an automated arm.

In a second alternative, the command generated is able to command the automaton to connect a repeater to the socket, or to the sockets depending on the type of repeater, located at the positioning coordinate determined for the repeater, notably by controlling a robotic arm of the automaton.

The provider of repeater positioning coordinates 16 notably comprises the command generator for an automaton 1618. The datum relating to the repeater rd then comprises the automaton command thus generated cmd.

In a first embodiment, the device 1 is a communications terminal able to connect to a wireless communications network comprising a provider 16 of at least one positioning coordinate of at least one repeater 21₁ . . . 21_{N} within a local area 3. The at least one positioning coordinate of a repeater rp, {rpⱼ}ⱼ is determined as a function at least of a position pp, {ppᵢ}ᵢ of at least one socket detected within the local area. The socket is detected using a captured video v, vl of the local area 3. For example, the provider 16 of at least one positioning coordinate of at least one repeater supplies at least one datum rd relating to at least one repeater comprising at least one positioning coordinate of a repeater rp, {rpⱼ}ⱼ: rd∈rpi^{k},rd⊃{rpiⱼ^{k}}_{j′}_{^{k=1,2}}.

In particular, the communications terminal 1 comprises an optimizer 19 of coverage of a local area by the wireless communications network. The optimizer 19 comprises the provider 16 of repeater positioning coordinates within the local area 3.

FIG. 2b illustrates a simplified diagram of one embodiment of the device notably illustrated in FIG. 2a in the form of an automaton according to an exemplary subject of the disclosure.

In a second embodiment, the device 1 is an automaton, notably such as illustrated in FIG. 2b, comprising:
at least one actuator 18, 18₁, 18₂′, 18₂″, 18₂′″ designed to perform a motor action am;
a transmitter/receiver 10 over a wireless communications network 2;
a provider 16 of at least one positioning coordinate of at least one repeater 21₁ . . . 21_{N} within a local area 3. The at least one positioning coordinate of a repeater rp, {rpⱼ}ⱼ is determined as a function at least of a position pp, {ppᵢ}ᵢ of at least one socket detected within the local area. The socket is detected using a captured video v, vl of the local area 3.

For example, the provider 16 of at least one positioning coordinate of at least one repeater supplies at least one datum rd relating to at least one repeater comprising at least one positioning coordinate of a repeater rp, {rpⱼ}ⱼ: rd⊃rpi^{k},rd⊃{rpiⱼ^{k}}_{j′}_{^{k=1,2}}. In the case where the actuator is a moving module 18₁, 18₂′, 18₂″, the motor action is a movement action: am=dpt. In the case where the actuator is a manipulator module 18₂′″, such as a robotic arm, the motor action is a manipulation action: am=mnp.

In particular, the automaton comprises an optimizer 19 of coverage of a local area by the wireless communications network. The optimizer 19 comprises the provider 16 of repeater positioning coordinates within the local area 3.

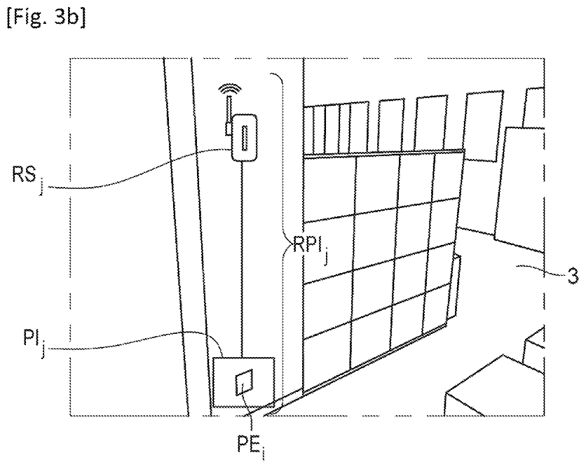

FIG. 3a shows a simplified diagram illustrating a map of coverage of the wireless communications network in which at least one repeater positioning indicator determined within the local area according to the disclosure is inserted.

The local area 3 illustrated in FIG. 3a is the plan of a dwelling composed of several rooms. A router 20 placed within the local area 3 generates and manages the wireless communications network 2. Owing to the position of this router 20 within the local area 3 and of the materials used for some walls in this local area 3, the wireless communications network 2 generated by the router does not cover the entirety of the local area 2. It only covers c₂₀ (cf. area with diagonal hatching) the living room (room in bottom right of the figure), a part of the kitchen (room in bottom left of the figure) but not the bedrooms (rooms in the top of the figure).

An exemplary subject of the disclosure allows repeater positioning coordinates to be determined as a function of the position (x₁,y₁), (x₂,y₂), (x₃,y₃), (x₄,y₄), (x₅,y₅) of sockets PE₁, PE₂, PE₃, PE₄, PE₅, PN₅ detected in a video captured within the local area 3 and at least one repeater indicator RPI_{F}, RPI_{SF1}, RPI_{SF2} to be inserted at the positioning coordinates thus determined in the map of coverage of the network, either in a map previously generated by updating the map or by directly generating a repeater positioning map.

The indicator notably comprises a frame, and/or a graphical symbol for a repeater, and/or an alphanumeric symbol for a repeater, or else for a type of repeater, and, potentially, a height position symbol (arrow) in the present example, in particular if the map is a two-dimensional map.

FIG. 3a illustrates the coverages generated by these repeaters, respectively c_{RPF} surrounded by a wavy line, c_{RPSF1} with horizontal hatching, and c_{RPSF1} with vertical hatching.

FIG. 3b shows an illustrative image of an insertion, either into a video or in augmented reality mode, of a repeater positioning indicator determined within the local area according to an exemplary subject of the disclosure.

FIG. 3b shows an image of a local area 3 either seen by the user in augmented reality mode or from a previously captured video. Into this image of the local area 3, the invention has added, inserted a repeater indicator RPIⱼ at a positioning coordinate determined for a repeater previously supplied by an exemplary subject of the disclosure.

The indicator notably comprises a frame pij, and/or a graphical symbol for a repeater rsj, and/or an alphanumeric symbol for a repeater, or else for a type of repeater, and potentially, a height position symbol (in particular, if the gaze of the user does not see in augmented reality mode the socket to which the repeater must be connected).

Thus, an exemplary subject of the disclosure allows an evaluation on a communications terminal, such as a smartphone, a tablet, a virtual and/or augmented reality headset or glasses, etc., of the coverage of a wireless communications network, notably wifi, of a local area, for example in augmented reality mode. The user moves around within the local area and, as he/she moves around, the terminal determines and, potentially, displays the quality of the wireless communications network, notably in augmented reality mode. The quality displayed is notably represented by labels with, for example, a color code and/or the effective value of the signal in decibels, dB. When the user has finished his/her mission, the terminal displays a map of the local area which it has evaluated on which a location of repeater(s), notably of wifi repeater(s), of the wireless communications network is potentially suggested in order to improve the quality of the signal in at least a part of the local area.

An exemplary subject of the disclosure provides a repeater location that is more precise than those generally provided by maps supplied by a communications terminal not equipped with Lidar (map too abstract), easier to use than those generally provided by maps supplied by a communications terminal equipped with a Lidar (map too detailed where all the objects of the local area are depicted) since an exemplary subject of the disclosure only depicts the sockets detected to which the repeaters may be connected either in terms of power supply or in terms of communications.

Indeed, as soon as the optimization method according to an exemplary subject of the disclosure is started, run, a video capture is started (for example a video capture of the screen of the smartphone on which is displayed an image from the camera of the smartphone augmented with a value of quality of the signal of the wireless communications network, such as a wifi signal). An analysis of the video determines the positions at which it is appropriate to position a repeater in order to improve the coverage of the wireless communications network; notably an electrically powered repeater can only be positioned at a position where an electrical socket is located, a repeater connectable to a router by wire, for example by Ethernet, can only be positioned at a position where a wired communications socket is located. The video analysis allows the sockets to be detected by detection of objects, e.g. at least with algorithms such as Yolo™, etc. This information on positions of sockets detected is coupled, notably, to the map of coverage of the wireless communications network, in particular the wifi map, in order to determine possible locations for one or more repeaters.

The provision of positioning coordinates of the repeaters thus determined are notably used for superposing, notably such as illustrated in FIG. 3b, at least one virtual element for example onto the captured video, in particular onto the video image of the video corresponding to at least one positioning coordinate of a repeater, thus indicating to the user where the repeater should be placed. These virtual elements are also called repeater indicators. The video thus modified, enhanced by the repeater indicator, is displayed by a communications terminal having potentially implemented an exemplary subject of the disclosure.

Potentially, a quality indicator could be used to modify, to enhance the video thus allowing the quality of the wireless communications network of the local area to be furthermore displayed with the video. Notably, the quality indicator is superposed, chroma keyed into a video image, or even modifies the video image, notably at least with a filter, such as a color and/or brightness filter, for example, associated with a position corresponding to the position of the quality indicator.

An exemplary subject of the disclosure implements one or more of the embodiments described on their own or in combination.

An exemplary subject of the disclosure is also aimed at a medium. The information medium may be any given entity or device capable of storing the program. For example, the medium may comprise a storage means, such as a ROM, for example a CD ROM or a microelectronic circuit ROM or else a magnetic recording means, for example a floppy disk or a hard disk.

Furthermore, the information medium may be a transmissible medium such as an electrical or optical signal which may be carried via an electrical or optical cable, by radio or by other means. The program according to an exemplary subject of the disclosure may in particular be up/downloaded over a network notably of the Internet type.

Alternatively, the information medium may be an integrated circuit into which the program is incorporated, the circuit being designed to execute or to be used in the execution of the method in question.

In another embodiment, an exemplary subject of the disclosure is implemented by means of software and/or hardware components. In this scenario, the term ‘module’ may just as easily correspond to a software component or to a hardware component. A software component corresponds to one or more computer programs, one or more sub-programs of a program, or more generally, to any element of a program or of a software application designed to implement a function or a set of functions according to the description hereinabove. A hardware component corresponds to any element of a hardware assembly designed to implement a function or a set of functions.

An exemplary aspect of the present disclosure overcomes at least one of the drawbacks of the prior art.

Although the present disclosure has been described with reference to one or more examples, workers skilled in the art will recognize that changes may be made in form and detail without departing from the scope of the disclosure and/or the appended claims.

1. An optimization method for optimizing a coverage by a wireless communications network of a local area, the method being implemented by a device and comprising:
provisioning at least one positioning coordinate of at least one repeater within the local area, the at least one positioning coordinate of a repeater being determined as a function at least of a position of the at least one socket detected within the local area, the socket being detected using a captured video of the local area.

2. The optimization method according to claim 1, the optimization method comprising detecting the position of the at least one socket within the local area, wherein the position of the at least one socket is detected using the captured video of the local area.

3. The optimization method according to claim 2, the optimization method comprising jointly capturing a video of the local area and a position associated with at least one video image of the video.

4. The optimization method according to claim 1, in which the at least one positioning coordinate of a repeater is furthermore determined as a function of positional data on quality of the wireless communications network.

5. The optimization method according to claim 4, in which the positional data on quality of the wireless communications network comprises a datum captured within the local area.

6. The optimization method according to claim 4, the optimization method comprising capturing the positional data on quality of the wireless communications network.

7. The optimization method according to claim 4, the optimization method comprising jointly capturing the data on quality of the wireless communications network and a position associated with the data on quality captured.

8. The optimization method according to claim 1, the optimization method comprising detecting the at least one socket using the captured video of the local area.

9. The optimization method according to claim 1, the optimization method comprising analyzing the captured video of the local area to detect the at least one socket within the local area.

10. The optimization method according to claim 1, the optimization method comprising determining the at least one position of the at least one socket detected as a function of at least one position associated with at least one video image of the captured video.

11. The optimization method according to claim 1, the optimization method comprising inserting into a graphical medium at least one indicator as a function of at least one repeater positioning coordinate determined within the local area.

12. The optimization method according to claim 11, in which the graphical medium comprises at least one medium from amongst:
a map of coverage generated as a function of captured positional data on quality of the wireless communications network;
the captured video of the local area;
an augmented reality medium.

13. A non-transitory computer readable medium comprising program code instructions stored thereon for execution an optimization method for optimizing a coverage by a wireless communications network of a local area, when said program is executed by a processor, wherein the method comprises:
provisioning at least one positioning coordinate of at least one repeater within the local area, the at least one positioning coordinate of a repeater being determined as a function at least of a position of the at least one socket detected within the local area, the socket being detected using a captured video of the local area.

14. A communications terminal designed to connect to a wireless communications network, wherein the communications terminal comprises:
at least one processor; and
at least one non-transitory computer readable medium comprising instructions stored thereon which when executed by the at least one processor configure the communications terminal to:
provision at least one positioning coordinate of at least one repeater within a local area, the at least one positioning coordinate of a repeater being determined as a function at least of a position of at least one socket within the local area, the position of the socket being detected using a captured video of the local area.

15. Automaton comprising:
at least one actuator designed to carry out a motor action;
a transmitter/receiver to communicate over a wireless communications network; and
a device comprising:
at least one processor; and
at least one non-transitory computer readable medium comprising instructions stored thereon which when executed by the at least one processor configure the communications terminal to provide at least one positioning coordinate of at least one repeater within a local area, the at least one positioning coordinate of a repeater being determined as a function at least of a position of at least one socket within the local area, the position of the socket being detected using a captured video of the local area.
